(19) United States
(12) Patent Application Publication
(10) Pub. No.: US 2026/0186379 A1
(43) Pub. Date: Jul. 2, 2026

(54) SEALING SYSTEM FOR A CAMERA AND AN OUTER REAR-VIEW MIRROR

(71) Applicant: MOTHERSON INNOVATIONS COMPANY LIMITED, London (GB)

(72) Inventors: Levente Acs, London (GB); Thorsten Staiger, London (GB)

(21) Appl. No.: 19/436,471

(22) Filed: Dec. 30, 2025

(30) Foreign Application Priority Data
Dec. 31, 2024 (DE) 102024139940.6

(51) Int. Cl. G03B 17/08; B60R 1/06; B60R 1/12; G03B 17/12

(52) U.S. Cl. CPC G03B 17/08; B60R 1/0602; B60R 1/12; G03B 17/12; B60R 2001/1253

(57) ABSTRACT

The present disclosure relates to a sealing system for a camera. The sealing system comprises a casing including a receptacle and a clearance element. The receptacle is configured to receive the camera. Further, the clearance element is configured to lid the receptacle to securely seal the camera between the receptacle and the clearance element. The present disclosure also relates to an outer rear-view mirror for a vehicle having the sealing system.

### CROSS-REFERENCE TO RELATED APPLICATIONS

This application claims the benefit of German Patent Application No. DE 102024139940.6, filed on Dec. 31, 2024, the content of which is incorporated herein by reference in its entirety.

The present disclosure relates to a sealing system. More particularly, the present disclosure relates to an outer rear-view mirror.

With increasing population around the world, number of vehicles have also increased. Further, camera systems have been introduced at various surfaces of the vehicles. For example, CN118025010A relates to an external rearview mirror having a camera system. The camera system has been introduced for providing safety to the vehicle user. The concept of Moving Off Information System and Camera Monitoring System is well known to the vehicle industry all around the globe. In general, the cameras protrude out through an opening in the surface of the vehicle, wherein the surface may be, but not limited to, a surface of an outer door handle, a surface of a dash-board, a surface of an outer rear-view mirror assembly. Further, the cameras may be mounted along with various assemblies or components. The various assemblies or components may be, but not limited to, a blower system, an actuator assembly and a heater. Further, the camera system may employ different techniques for cleaning of a lens of the camera. However, the cleaning process pose a threat of leaking of a cleaning fluid into the surface causing damage to the various assemblies or components mounted in the vicinity of the camera system.

Therefore, there is a need to develop a system which overcomes above-mentioned shortcoming.

This object is solved by a sealing system for a camera of claim 1. Advantageous configurations, embodiments and developments emerge from the further dependent claims and from the description with reference to the figures of the drawings.

According to an aspect of the present disclosure, a sealing system for a camera is disclosed. The system comprising: a casing including a receptacle and an aperture, wherein the receptacle comprises at least one wall protruding from the casing, wherein the at least one wall comprises a top face; and a clearance element having a central hole, the clearance element comprising a first face, wherein the central hole of the clearance element is configured to enable at least partially passing through of the camera such that the central hole gets sealed by the camera, and the first face of the clearance element is configured to lid the top face of the at least one wall of the receptacle to securely seal the camera between the receptacle and the clearance element. In an embodiment, the present disclosure further comprises a camera lens, wherein the camera is arranged such that the camera lens is facing the aperture. In an embodiment, the present disclosure further comprises at least one outer surface configured to seal the central hole when the camera is attached to the aperture. In an embodiment of the present disclosure, the clearance element comprises a peripheral hole configured to receive a cleaning fluid. This results in compartmentalization for the camera and eliminates the threat of leaking of a cleaning fluid into surrounding of the camera.

In an embodiment, the present disclosure further comprising a channel formed between an inner face of the wall and at least one of: the clearance element and the camera. In an embodiment of the present disclosure, the channel is configured to receive the cleaning fluid from the peripheral hole and pass the cleaning fluid towards the camera lens. In an embodiment of the present disclosure, the channel is formed by the inner face of the wall, the clearance element and the outer surface of the camera. In an embodiment of the present disclosure, the channel is formed by the inner face of the wall and an extended wall protruding from the first face of the clearance element. This provides a pathway for the cleaning fluid.

In an embodiment the present disclosure, the cleaning fluid is at least one of air and liquid.

An outer rear-view mirror for a vehicle comprising the sealing system in accordance with any of the above embodiments. In an embodiment the present disclosure, the casing of the sealing system is formed by a cover of the outer rear-view mirror.

Therefore, the present disclosure provides a sealing system for a camera which reduces leaking of a cleaning fluid into the surface. Further, the present disclosure provides an outer rear-view mirror having the sealing system for the camera.

Other aspects, advantages, and salient features of the present disclosure will become apparent to those skilled in the art from the following detailed description, which taken in conjunction with the annexed drawings, discloses exemplary embodiments of the disclosure, wherein:

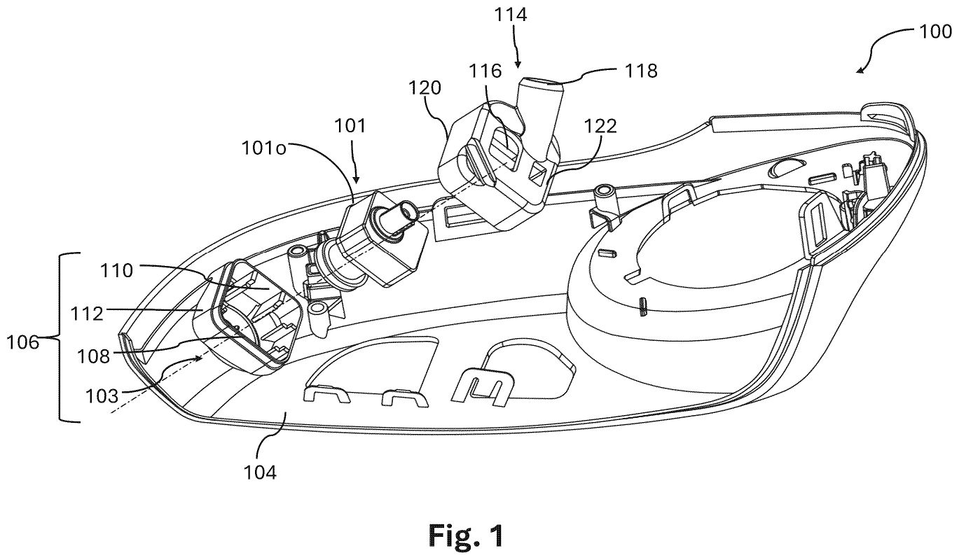

FIG. 1 illustrates an exploded view of a sealing system in accordance with a first embodiment of the present disclosure.

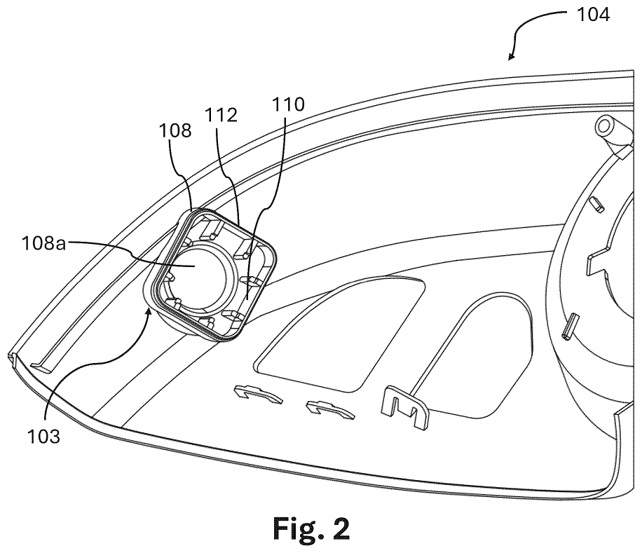

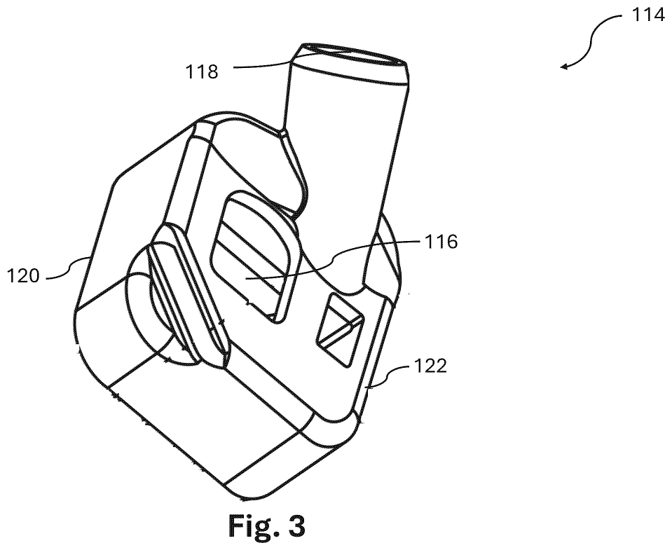

FIG. 2 illustrates a perspective view of a casing in accordance with the first embodiment of the present disclosure.

FIG. 3 illustrates a perspective view of a clearance element in accordance with the first embodiment of the present disclosure.

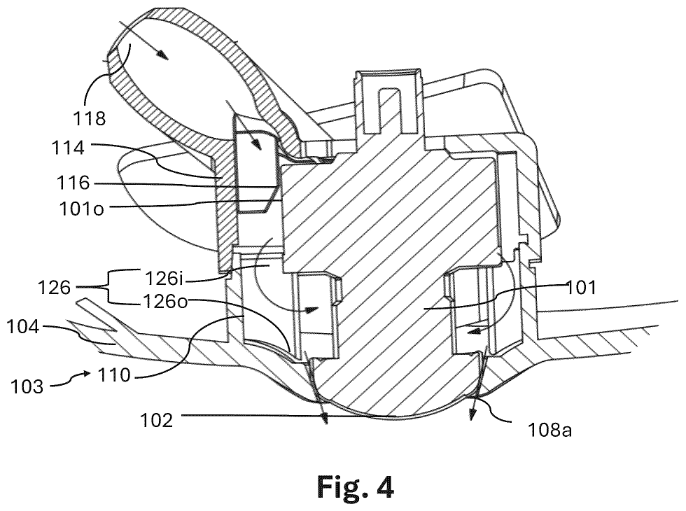

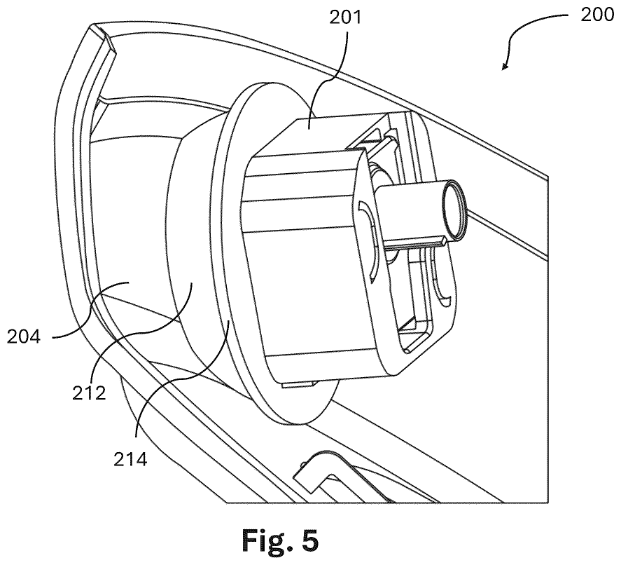

FIG. 4 illustrates a sectional view of the sealing system with the clearance element in accordance with the first embodiment of the present disclosure.

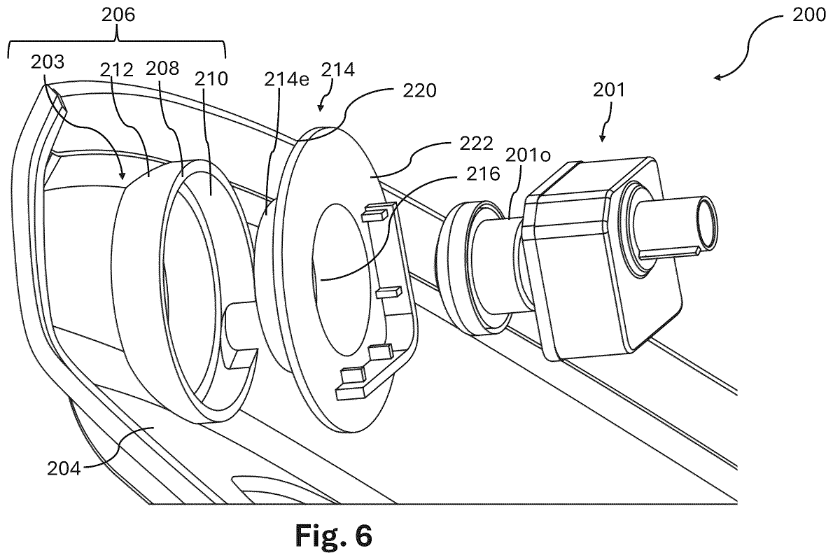

FIG. 5 illustrates an assembled view of a sealing system having a casing and a clearance element in accordance with a second embodiment of the present disclosure.

FIG. 6 illustrates an exploded view of the sealing system in accordance with the second embodiment of the present disclosure.

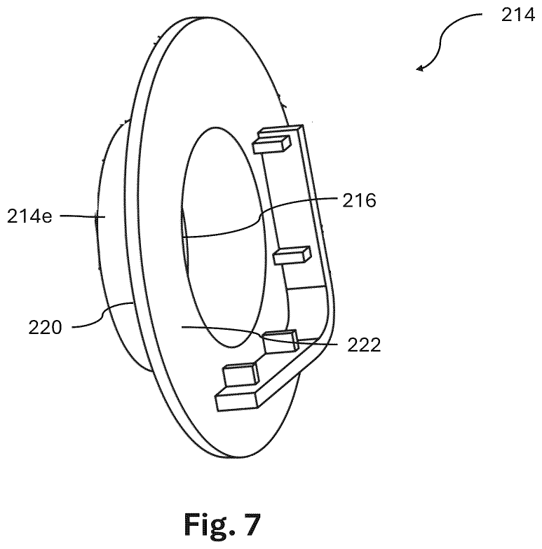

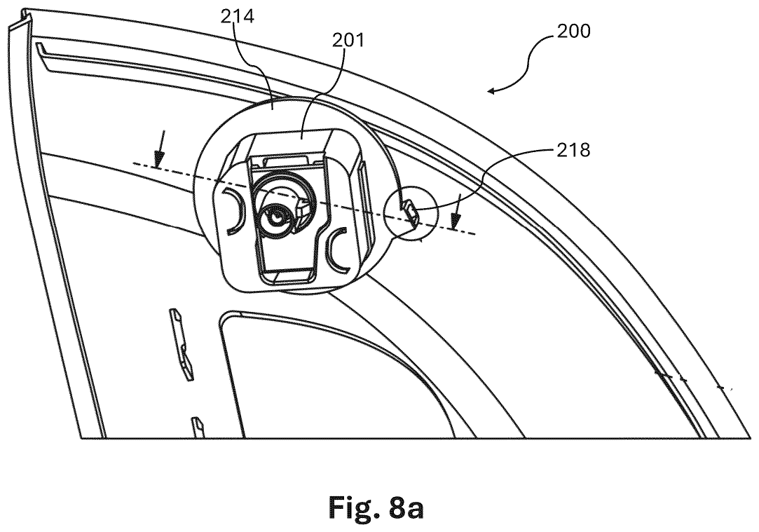

FIG. 7 illustrates a perspective view of the clearance element in accordance with the second embodiment of the present disclosure.

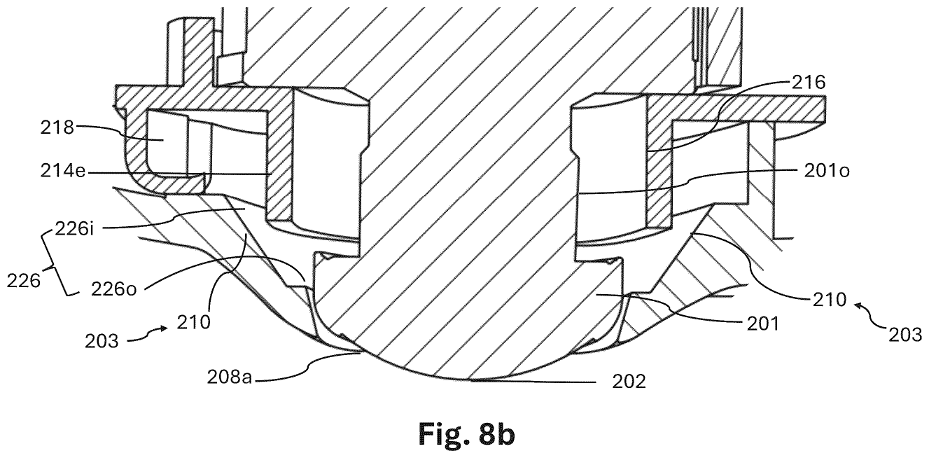

FIG. 8a illustrates a perspective view of the sealing system in accordance with the second embodiment of the present disclosure.

FIG. 8b illustrates a sectional view of the sealing system with the clearance element in accordance with the second embodiment of the present disclosure as shown in FIG. 8a.

The drawings referred to in this description are not to be understood as being drawn to scale except if specifically noted, and such drawings are only exemplary in nature.

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, like reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals e.g., first, second, etc. used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

While the present invention is illustrated in the context of a four-wheeled vehicle, however, holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

FIG. 1 illustrates an exploded view of a sealing system 100 encompassing a casing 104, a clearance element 114 and a camera 101. In an embodiment, the casing 104 may be a surface. In another embodiment, the casing 104 may be a cover. In an embodiment, the casing 104 may be a cover of an outer rear-view mirror. Further, as shown in FIG. 2, the casing 104 encompasses a receptacle 106 and an aperture 108a. The receptacle 106 acts as a receiving zone for receiving the camera 101 and the clearance element 114. The receptacle 106 comprises at least one wall 103 protruding from the casing 104. In an embodiment, the receptacle 106 and the casing 104 are a uni-body. The at least one wall 103 may have a top face 108, an inner face 110 and an outer face 112. In an embodiment, the receptacle 106 may have four walls. In another embodiment, the receptacle 106 may have a single circular wall. Further, the inner face 110 of the at least one wall 103 may surround the aperture 108a. The aperture 108a, as shown in FIG. 4, may be configured to receive a camera lens 102 of the camera 101. Further, as shown in FIG. 1, the top face 108 may be configured to receive the clearance element 114.

FIG. 3 shows a perspective view of the clearance element 114 in accordance with an embodiment. The clearance element 114 may be a plate shaped member having a first face 120 and a second face 122. In another embodiment, the clearance element 114 may be a disc shaped member. Further, the clearance element 114 may have a central hole 116 passing through the first face 120 and the second face 122. The clearance element 114 may have a peripheral hole 118 at least partially on the second face 122. The central hole 116 of the clearance element 114 may be configured to enable passing through of a part of the camera 101 such that the central hole 116 gets sealed by the camera 101. More particularly, as shown in FIG. 4, at least one outer surface 101o of the camera 101 may seal the central hole 116. The first face 120 of the clearance element 114 may be configured to lid the top face 120 of the at least one wall 103 of the receptacle 106 to securely seal the camera 101 between the receptacle 106 and the clearance element 114.

Further, as shown in FIG. 4, a channel 126 may formed between the inner face 110 of the wall 103, the clearance element 114 and the camera 101. More particularly, the channel 126 may be formed by the inner face 110 of the wall 103, the clearance element 114 and the outer surface 101o of the camera 101. The channel 126 may have first portion 126i and a second portion 126o such that the first portion 126i may be configured to receive a cleaning fluid, wherein the cleaning fluid is at least one of air and liquid. Further, the first portion 126i may pass the cleaning fluid towards the second portion 126o. Further, the second portion 126o face towards the camera lens 102 to enable passing of the cleaning fluid towards the camera lens 102.

Similarly, FIG. 5 illustrates an assembled view of a sealing system 200 encompassing a casing 204, a camera 201, and a clearance element 214. Further, FIG. 6 illustrates an exploded view of the sealing system 200 encompassing the casing 204, the clearance element 214, and the camera 201. Further, in an embodiment, the casing 204 may be a surface. In another embodiment, the casing 204 may be a cover. In an embodiment, the casing 204 may be a cover of an outer rear-view mirror. Further, the casing 204 encompasses a receptacle 206 and an aperture 208a. The receptacle 206 acts as a receiving zone for receiving the camera 201 and the clearance element 214. The receptacle 206 comprises at least one wall 203 protruding from the casing 204. In an embodiment, the receptacle 206 and the casing 204 are a uni-body. The at least one wall 203 may have a top face 208, an inner face 210 and an outer face 212. In embodiment, the receptacle 206 may have four walls. In another embodiment, the receptacle 206 may have a single circular wall. Further, the inner face 210 of the at least one wall 203 may surround the aperture 208a. The aperture 208a, as shown in FIG. 8b. may be configured to receive a camera lens 202 of the camera 201. Further, as shown in FIG. 6, the top face 208 may configured to receive the clearance element 214.

As shown in FIG. 7, the clearance element 214 may be a plate shaped member having a first face 220 and a second face 222. In another embodiment, the clearance element 214 may be a disc shaped member. Further, the clearance element 214 may have a central hole 216 passing through the first face 220 and the second face 222. Further, the central hole 216 of the clearance element 214 may be configured to enable passing through of a part of the camera 201 such that the central hole 216 gets sealed by the camera 201. More particularly, as shown in FIG. 8b, at least one outer surface 201o of the camera 201 may seal the central hole 216. The clearance element 214 may have a peripheral hole 218 (also shown in FIG. 8a) at least partially on the second face 222. The first face 220 of the clearance element 214 may be configured to lid the top face 220 of the at least one wall 203 of the receptacle 206 to securely seal the camera 201 between the receptacle 206 and the clearance element 214.

The clearance element 214 may also have an extended wall 214e protruding from the first face 220 of the clearance element 214. As shown in FIG. 7b, a channel 226 may formed between the inner face 210 of the wall 203 and the clearance element 214. More particularly, wherein the channel 226 may be formed by the inner face 210 of the wall 203 and the extended wall 214e of the clearance element 214. The channel 226 may have a first portion 226i and a second portion 226o such that the first portion 226i may be configured to receive a cleaning fluid, wherein the cleaning fluid is at least one of air and liquid. Further, the first portion 226i may pass the cleaning fluid towards the second portion 226o. Further, the second portion 226o face towards the camera lens 202 to enable passing of the cleaning fluid towards the camera lens 202.

Therefore, the present disclosure provides a sealing system for a camera which reduces leaking of a cleaning fluid into the surface. In addition, the sealing system provides a compartmentalization for the camera.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims, i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

1. A sealing system for a camera, the sealing system comprising:
a casing including a receptacle and an aperture, wherein the receptacle comprises at least
one wall protruding from the casing, wherein the at least one wall comprises a top face; and
a clearance element having a central hole, the clearance element comprising a first face, wherein
the central hole of the clearance element is configured to enable at least partially passing through of the camera such that the central hole gets sealed by the camera, and
the first face of the clearance element is configured to lid the top face of the at least one wall of the receptacle to securely seal the camera between the receptacle and the clearance element.

2. The sealing system in accordance with claim 1, wherein the camera comprises a camera lens, wherein the camera is arranged such that the camera lens is facing the aperture.

3. The sealing system in accordance with claim 2, wherein the camera further comprises at least one outer surface configured to seal the central hole when the camera is attached to the aperture.

4. The sealing system in accordance with claim 1, wherein the clearance element comprises a peripheral hole configured to receive a cleaning fluid.

5. The sealing system in accordance with claim 1, wherein the sealing system further comprising a channel formed between an inner face of the wall and at least one of: the clearance element and the camera.

6. The sealing system in accordance with claim 5, wherein the channel has a first portion and a second portion such that the first portion is configured to receive the cleaning fluid from the peripheral hole, and the second portion of the channel is configured to pass the cleaning fluid towards the camera lens.

7. The sealing system in accordance with claim 5, wherein the channel is formed by the inner face of the wall, the clearance element and the outer surface of the camera.

8. The sealing system in accordance with claim 5, wherein the channel is formed by the inner face of the wall and an extended wall protruding from the first face of the clearance element.

9. The sealing system in accordance with claim 4, wherein the cleaning fluid is at least one of air and liquid.

10. An outer rear-view mirror for a vehicle comprising a sealing system, the sealing system comprising:
a casing including a receptacle and an aperture, wherein the receptacle comprises at least one wall protruding from the casing, wherein the at least one wall comprises a top face; and
a clearance element having a central hole, the clearance element comprising a first face, wherein
the central hole of the clearance element is configured to enable at least partially passing through of the camera such that the central hole gets sealed by the camera, and
the first face of the clearance element is configured to lid the top face of the at least one wall of the receptacle to securely seal the camera between the receptacle and the clearance element.

11. The outer rear-view mirror for the vehicle in accordance with claim 10, wherein the casing of the sealing system is formed by a cover of the outer rear-view mirror.
